(19) United States
(12) Patent Application Publication
(10) Pub. No.: US 2013/0257583 A1
(43) Pub. Date: Oct. 3, 2013

(54) WIRELESS COMMUNICATION DEVICE AND METHOD WITH ULTRASONIC DETECTION

(71) Applicant: Siddharth Sinha, Minneapolis, MN (US)

(72) Inventor: Siddharth Sinha, Minneapolis, MN (US)

(73) Assignee: MOTOROLA MOBILITY, INC., Libertyville, IL (US)

(21) Appl. No.: 13/450,705

(22) Filed: Apr. 19, 2012

Related U.S. Application Data
(60) Provisional application No. 61/617,285, filed on Mar. 29, 2012.

(51) Int. Cl. G05B 23/02

(52) U.S. Cl. 340/3.1

(57) ABSTRACT

A wireless communication device (200) and method (300) with ultrasonic detection, is described. In its simplest form, the method (300) includes: periodically transmitting (310) ultrasonic signals from a wireless communication device; sensing (320) a reflection of the ultrasonic signals: and if a threshold is met, adjusting (330) an operating mode of the wireless communication device. The method (300) can enhance a user's experience, by launching a desired application, when a certain threshold is met.

### BACKGROUND

1. Field

The present disclosure relates to a wireless communication device and method with ultrasonic detection.

2. Introduction

Wireless communication devices are multi-functional, with each function or application, satisfying a user's purpose. Since user's utilize such devices to such an extent, lowering power consumption has become quite important. In connection with reducing power consumption and network interaction, efforts have been made to limit power intensive phone features and applications (such as syncing with applications, checking for updates, location based services, etc.), to operate only in limited instances when the user is actually interacting with the phone, while staying in a dormant or low-power sleep mode at other instances.

Various techniques for detecting user interaction with a device have been tried. They include imagers, thermal sensors to detect body heat, proximity sensing, capacitive and resistive sensors to detect touch and accelerometers to detect motion. They have met with limited successes.

It would be considered an improvement in the art, if a wireless communication device could reliably and accurately detect user physical presence. This could help to reduce unnecessary battery consumption and interaction with a network, when the device is not being used by a user, such as when in a purse, pocket, or a user is focused on another task.

It would also be considered an improvement in the art, if a wireless communication device would launch a desired feature, when detecting user physical presence.

Accordingly, there is a need to maximize the operational time of a device using a battery. Likewise, there is also a need to disable and/or enable certain operational modes, when a user physical presence or absence is detected.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of a communication system according to one embodiment;

FIG. 2 is an exemplary block diagram of a wireless communication device with ultrasonic detection, according to one embodiment;

FIG. 3 is an exemplary block diagram of a wireless communication method with ultrasonic detection, according to one embodiment; and

FIG. 4 is a chart of illustrative examples of a wireless communication device with ultrasonic detection, according to one embodiment.

### DETAILED DESCRIPTION

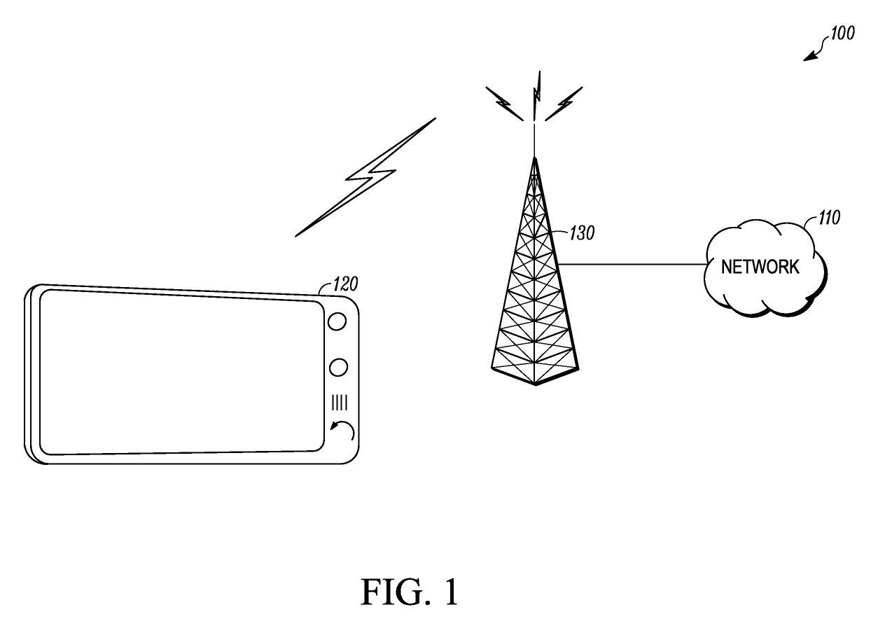

FIG. 1 is an exemplary block diagram of a system 100 according to one embodiment. The system 100 can include a network 110, a terminal 120, and a base station 130. The terminal 120 may be a wireless communication device, such as a wireless telephone, a cellular telephone, a personal digital assistant, a pager, a personal computer, a tablet, a selective call receiver, or any other device that is capable of sending and receiving communication signals on a network including wireless network. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, a Third Generation (3G) network, a satellite communications network, and other like communications systems. Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals. In operation, the terminal 120 can communicate with the network 110 and with other devices on the network 110 by sending and receiving wireless signals via the base station 130.

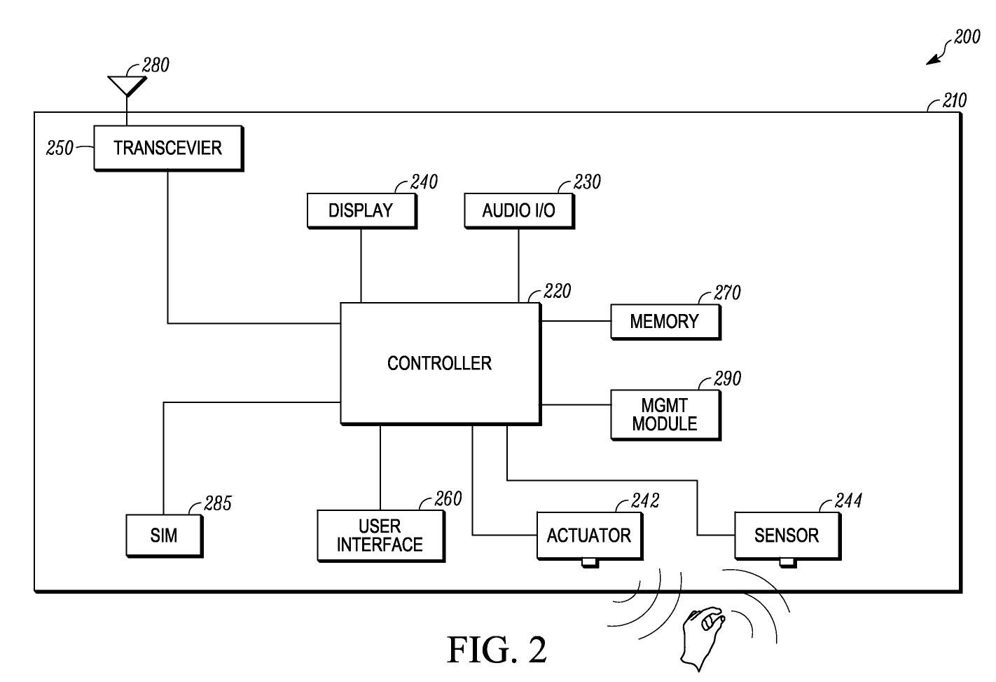

FIG. 2 is an exemplary block diagram of a wireless communication and/or computing device 200, such as the terminal 120, according to one embodiment. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210 and the transceiver 250, and a removable subscriber module (SIM) 285 coupled to the controller 220.

The wireless communication device 200 can include a management module 290 coupled to the controller 220. The management module 290 can reside within the controller 220, can reside within the memory 270, can be autonomous modules, can be software, can be hardware, or can be in any other format useful for a module on a wireless communication device 200.

The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory or any other memory that can be coupled to a wireless communication device.

The wireless communication device 200 in FIG. 2 further shows an actuator 242 configured to transmit ultrasonic signals and a sensor 244 configured to receive reflected ultrasonic signals; a controller 220 coupled to the wireless communication device 200, the controller 220 configured to control the operations of the wireless communication device; and a management module 290 connected to the actuator 242 and sensor 244, configured such that when a threshold reflected ultrasonic signal is met or achieved, a desired operating mode of the wireless communication device is adjusted or application launched, as detailed herein. Advantageously, the wireless communication device 200 can enhanced a user's experience, by launching certain desired applications when a certain threshold reflected ultrasonic signal is met.

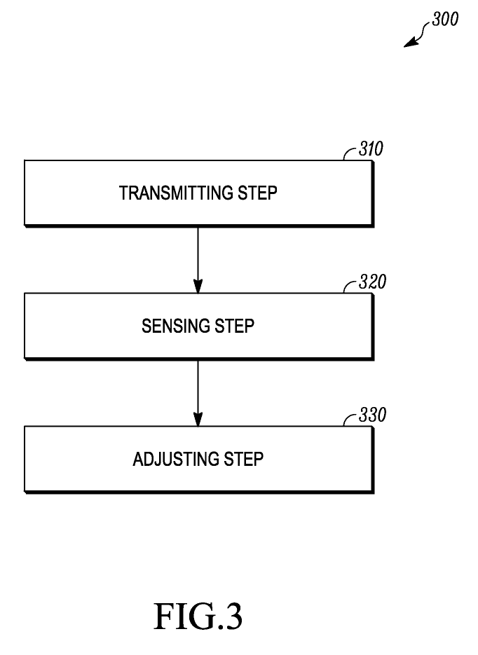

In FIG. 3, a block diagram of a wireless communication method with ultrasonic detection 300, is shown. In its simplest form, the method 300 includes: periodically transmitting 310 ultrasonic signals from a wireless communication device; sensing 320 a reflection of the ultrasonic signals: and if a threshold is met, adjusting 330 an operating mode of the wireless communication device.

The method 300 can enhance a user's experience, by launching a desired application, when a certain threshold reflected ultrasonic signal is met. Conversely, the method can provide power savings default, when a certain threshold is not met, by the operating mode entering a mode.

In one embodiment, the transmitted ultrasonic signals are in a range of about 1-3 Mhz. In this range, human living tissue is highly sensitive to ultrasonic acoustic energy, thus accurate and reliable readings or detections can be obtained.

In one embodiment, the transmitting step 310 can include acoustically transmitting a single high frequency ultrasonic sine pulse, for a predetermined duration, to determine human presence. For example, a piezoelectric actuator can be provided to transmit a single high frequency ultrasonic sine pulse, for a predetermined duration of 1-5 seconds, defining a ping.

In one embodiment, the transmitting step 310 includes providing an actuator and the sensing step 320 includes providing a sensor configured to receive reflective ultrasonic signals.

In one embodiment, the sensor and the actuator can include a single common or integrated piezoelectric element or they can be different elements, such as one near or integrated with an ear piece and a second near or integrated with a microphone, in a wireless communication device.

The sensing step 320 can include processing and analyzing the reflected ultrasonic signals by comparing them with the periodically transmitted ultrasonic signal of step 310. The comparing can be done in various ways. By example, the comparing can be done in a time domain or frequency domain. For example, the time domain can include pulse width and amplitude components and the frequency domain comparison can include frequency content and amplitude components, as should be understood by those skilled in the art.

The adjusting step 330 can include adjusting an operating mode of the wireless communication device by using a power management application to lower power drain based on the sensed reflection or signature. For example, based on the sensed reflection or signature, the operating mode adjustment can be made to proactively and intelligently minimize power consumption.

In one use case, the device 200 could be set to a dormant or sleep mode, when a certain threshold is not met, such as human tissue in not sensed. For example, if a device is not in physical possession of a user (or certain threshold is not met in Step 320), a display could be disabled.

In a second case, when a device 200 is determined to be in close proximity to a user (or threshold is met in Step 320), such as a cell phone is placed in a talking position near a user's ear, the display can be quickly triggered to a disabled mode, as the user cannot see the display and it would be useful to disable the display, for power savings, at this instance. When the user moves the device 200 away (or threshold is not met in Step 320), the display could be quickly re-enabled, to allow the user to view the display, in one embodiment.

In a third case, when a device is determined not to be in close proximity to a user (or threshold is not met in Step 320), power intensive network applications and/or interactions can be disabled or minimized, by adjusting the operating mode to be in a power saving dormant mode.

In one embodiment, the sensing step 320 can include sensing a reflection of the ultrasonic signals and if a threshold is met, and adjusting an operating mode of the wireless communication device, the threshold can include a first threshold and a second threshold. For example, a device can sense or detect at least 2 or more positions on or near a human body, depending on the detected level or sensed signature, or whether the first or the second threshold is met.

Also the amplitude and signature of the response sensed by a device can differ when the device is held over different parts of the human body due to the different tissue-bone density in various parts of the human body. Thus, the device or method 300 can discern where on the human body is the device present, for example, whether it is in the user's hands, pressed against his or her face in a talking/listening position, in a pocket, in a purse, etc. The operating mode can be adjusted with this in mind, to accommodate a user's preference.

Thus, a device 200 can be adjusted, based on the sensed reflection signals, as desired, to customize, enable or disable various operating mode. For example, a display(s), display illumination, keypad, key, user, input or button illumination, backlighting, screen navigation, touchscreen, paging speeds, etc., can be adjusted, as should be understood.

The method 300 can further comprise an energy storage device comprising at least one of a battery, a fuel cell, a fuel container and an electrochemical capacitor. The method 300 can help to improve power management and battery life, in a wireless communication device.

As shown in FIG. 2, a wireless communication device 200 with ultrasonic detection is shown. In its simplest form, it can include: a wireless communication device 200 including an actuator 242 configured to transmit ultrasonic signals and a sensor 244 configured to receive reflected ultrasonic signals; a controller 220 coupled to the wireless communication device 200, the controller 220 configured to control the operations of the wireless communication device; and a management module 290 connected to the actuator 242 and sensor 244, configured such that when a threshold reflected ultrasonic signal is achieved, an operating mode of the wireless communication device is adjusted. Advantageously, the wireless communication device 200 can enhance a user's experience, by launching a desired application when a certain threshold reflected ultrasonic signal is met. Also, the device 200 can provide power savings when not in a suitable position with respect to human tissue.

In one embodiment, the actuator 242 and the sensor 244 comprise a piezoelectric element, which can be the same or different elements, as previously stated.

The management module 290 can include a power management application to lower power drain based on the sensed reflected ultrasonic signals. For example, based on the sensed reflection signature (or echo), operating mode adjustments can be made to proactively and intelligently minimize power consumption, as previously detailed.

Also, when a device is determined not to be in close proximity to a user, power intensive network applications and/or interactions can be disabled, slowed or minimized, by adjusting the operating mode to be in a power saving mode.

The management module 290 in one embodiment, can be configured to sense a first threshold and a second threshold, such that when a first threshold reflected ultrasonic signal is achieved, a first operating mode of the wireless communication device is adjusted or application is launched, and when a second threshold reflected ultrasonic signal is achieved, a second operating mode of the wireless communication device is adjusted or application is launched. This feature can provide enhanced user customization and power savings.

For example, the device 200 can sense when the first or the second threshold is met. In more detail, the amplitude of the reflected ultrasonic signal, sensed by a device can differ when the device is held over different parts of the human body, due to the different tissue-bone density in different parts of the human body. The device 200 can discern where on the human body the device is present, based on the reflected ultrasonic signal (or signature), or whether the first or second threshold has been met. This can include for example, whether it is in the user's hands, pressed against his face, held by two hands in a texting position, etc. The operating mode can be adjusted with this in mind, to accommodate a user's preference. Thus, various operating modes can be adjusted, based on the sensed reflection signals.

In one embodiment, the actuator 242 can include a low cost, off the shelf actuator, such as a piezoelectric disc, such as one used's in Motorola Mobility's Rokr E8. It is a low cost actuator 242 which can generate a single frequency ultra high frequency acoustic signal (1-3 MHz sound waves) when excited with a voltage signal.

In connection with an electrical drive circuit, a single ultra high frequency signal generator (1 to 3 MHz frequency range) can be used to control and drive the piezo actuator (piezo) and generate the acoustic detection pulse. In one embodiment, the typical high voltage amplifier needed for the piezo is not needed and the piezo can be run in the low voltage mode (1-10 volts) as only sound waves are needed, which can simplify the electronics required to drive the piezo actuator, in this embodiment.

In one embodiment, the sensor 244 can include a low cost, off the shelf sensor, such as a PZT disc, like the type used in Rokr E8, which can give an output signal (voltage) when stressed and strained due to the echo of the actuator generated acoustic pulse's echo of human/living tissue. As previously stated, the sensor 244 and actuator 242 can be the same element.

In one embodiment, the signal processing can include a simple software program and/or circuitry to analyze the signal obtained from the sensor and compare it with the sent out echo either in time domain (pulse width/amplitude) or after an FFT in the frequency domain (frequency content/amplitude), as previously detailed.

In one embodiment, a simple power management algorithm can be provided to reduce or power off power hungry device features and applications, and minimize power intensive network interactions, when the user is not physically in possession or interacting with the device.

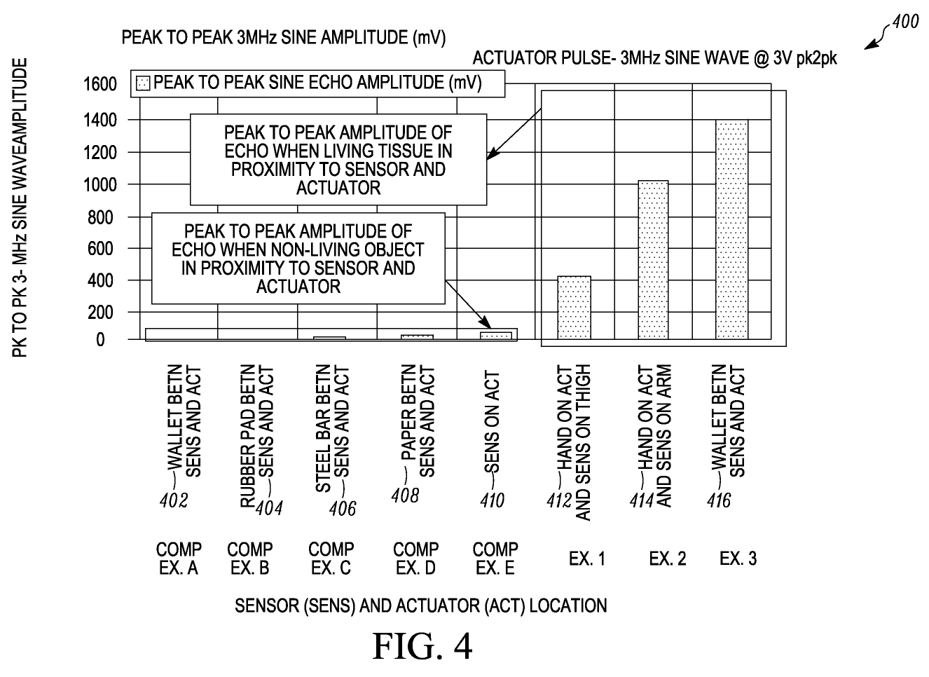

FIG. 4 is a chart 400 that plots the peak to peak amplitude (in millivolts) of a 3 MHz sound Sine Wave echo heard by a piezo sensor. A first plate was provided with an actuator and a second plate with a sensor. They were connected to standard lab electronics and an oscilloscope, for measuring and recording the data herein. The actuator pulse was a 3 Mhz sine wave at 3 V peak to peak. The vertical axis is in mVs, and the horizontal axis describes sensor and actuator locations.

In Comparative Example A, at point 402, a wallet was placed between the sensor and the actuator. No echo was received by the sensor.

In Comparative Example B, at point 404, a rubber pad was placed between the sensor and the actuator. No echo was received by the sensor.

In Comparative Example C, at point 406, a steel bar was placed between the sensor and the actuator. A minimal echo was received and measured by the sensor.

In Comparative Example D, at point 408, a paper towel was placed between the sensor and the actuator. A minimal echo was received and measured by the sensor.

In Comparative Example E, at point 410, a sensor and actuator were placed one on top of the other. A minimal echo was received and measured by the sensor.

In Example 1, at point 412, a human hand was placed on the actuator and the sensor was placed on the same person's thigh. An echo of 400 mV was measured. In Example 2, at point 414, a person's palm was placed on the actuator and the sensor was placed on the same person's wrist. An echo of 1000 mV was measured.

In Example 3, at point 416, a person's hand was placed between the actuator and the sensor. An echo of 1400 mV was measured.

From the results in this chart, it is clear that when living tissue is present in proximity to a sensor and actuator, the sensor picks up a much stronger signal (higher peak to peak amplitude) and the picked up signal has a more correct frequency (3 MHz), than when a non living object is present in proximity to the sensor and actuator, and the picked up frequency is different from 3 MHz and appears to be random noise.

Also depending on where the sensor is placed with respect to a human body, the level of echo changes, thus allowing the sensor and associated circuitry, to determine where on the human body a wireless communication device is located.

A few advantages of various embodiments of device 200 and method 300, are provided below:
High frequency transducer, (an actuator and a sensor, or a single element serving both functions can be provided in one embodiment.)
Use of a frequency band from 1 to 3 MHz which provides reliable feedback with human tissue.
Electronics to drive and receive vibrations are simple.
Algorithm to differentiate and distinguish between living tissue and non-living tissue contact is uncomplicated.
Detect handling depending on outgoing-incoming vibration signature.
Ping surroundings periodically to determine handling condition.
Once location/situation is determined, can put into sleep mode. Algorithm to put power off power intensive device features and network interactions when human presence is not detected.
Awake on any phone feature actuation (in-coming call, SMS, etc.)

The devices 120 and 200 and method 300 are preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A wireless communication method with ultrasonic detection, comprising:
periodically transmitting ultrasonic signals from a wireless communication device;
sensing a reflection of the ultrasonic signals; and
if a threshold is met, adjusting an operating mode of the wireless communication device.

2. The wireless communication method of claim 1, wherein the transmitted ultrasonic signals are in a range of about 1-3 Mhz.

3. The wireless communication method of claim 1, wherein if the reflection threshold is not met, the operating mode enters a sleep or dormant mode.

4. The wireless communication method of claim 1, wherein the periodically transmitting ultrasonic signals step includes acoustically transmitting a single high frequency ultrasonic sine pulse, for a predetermined duration, to determine human presence.

5. The wireless communication method of claim 1, wherein the periodically transmitting ultrasonic signals step includes providing an actuator configured to acoustically transmit a single high frequency ultrasonic sine pulse, for a predetermined duration, defining a ping.

6. The wireless communication method of claim 1, wherein the sensing step includes providing a sensor configured to receive reflective ultrasonic signals.

7. The wireless communication method of claim 1, wherein the periodically transmitting ultrasonic signals step includes providing an actuator and the sensing step includes providing a sensor configured to receive reflective ultrasonic signals.

8. The wireless communication method of claim 1, wherein the periodically transmitting ultrasonic signals step includes providing an actuator and the sensing step includes providing a sensor configured to receive reflective ultrasonic signals, the sensor and the actuator include a piezoelectric element.

9. The wireless communication method of claim 1, wherein the periodically transmitting ultrasonic signals step includes providing an actuator and the sensing step includes providing a sensor configured to receive reflective ultrasonic signals, the sensor and actuator each include a piezoelectric element.

10. The wireless communication method of claim 1, wherein the sensing step includes processing and analyzing the reflected ultrasonic signals by comparing them with the periodically transmitted ultrasonic signal.

11. The wireless communication method of claim 1, wherein the sensing step includes processing and analyzing the reflected ultrasonic signals by comparing them with the periodically transmitted ultrasonic signal, in at least one of time domain and frequency domain.

12. The wireless communication method of claim 1, wherein the adjusting an operating mode of the wireless communication device includes providing power management application to lower power drain based on the sensed reflection.

13. The wireless communication method of claim 1, wherein the sensing step includes sensing a reflection of the ultrasonic signals and if a threshold is met, and adjusting an operating mode of the wireless communication device, the threshold including a first threshold and a second threshold.

14. The wireless communication device of claim 1, further comprising an energy storage device comprising at least one of a battery, a fuel cell, a fuel container and an electrochemical capacitor.

15. A wireless communication device with ultrasonic detection, comprising:
a wireless communication device including an actuator configured to transmit ultrasonic signals and a sensor configured to receive reflected ultrasonic signals;
a controller coupled to the wireless communication device, the controller configured to control the operations of the wireless communication device; and
a management module connected to the actuator and sensor, configured such that when a threshold reflected ultrasonic signal is achieved, an operating mode of the wireless communication device is adjusted.

16. The wireless communication device of claim 15, wherein the transmitted ultrasonic signals are in a range of about 1-3 Mhz.

17. The wireless communication device of claim 15, wherein the actuator includes acoustically transmitting a single high frequency ultrasonic sine pulse, for a predetermined duration, to determine human presence.

18. The wireless communication device of claim 15, wherein the actuator and the sensor comprise a piezoelectric element.

19. The wireless communication device of claim 15, wherein the management module includes a power management application to lower power drain based on the sensed reflected ultrasonic signals.

20. The wireless communication device of claim 15, wherein the management module is configured to sense a first threshold and a second threshold, such that when a first threshold reflected ultrasonic signal is achieved, an operating mode of the wireless communication device is adjusted and when a second threshold reflected ultrasonic signal is achieved, an operating mode of the wireless communication device is adjusted.
